(19) United States
(12) Patent Application Publication
(10) Pub. No.: US 2011/0135108 A1
(43) Pub. Date: Jun. 9, 2011

(54) DUAL-FUNCTIONAL EARPHONE

(76) Inventor: CHIN WEI CHIEN, Jhonghe City (TW)

(21) Appl. No.: 12/633,799

(22) Filed: Dec. 9, 2009

(51) Int. Cl. H04R 1/10; H04B 5/00

(52) U.S. Cl. 381/74; 455/41.1

(57) ABSTRACT

A dual-functional earphone is disclosed, comprising a main casing, an earpiece, a microphone, a switch portion and a circuit device. The earpiece is disposed on a upper portion of the main casing and the microphone is disposed on a lower portion of the main casing, in which the microphone is provided with a general microphone and a vibration-based microphone; the switch portion is disposed on a surface of the main casing; the circuit device is disposed inside the main casing and electrically connected to the earpiece, the microphone and the switch portion. The dual-functional earphone according to the present invention allows users to communicate in various environments distinctly.

### BACKGROUND OF THE INVENTION

1. Field of the Invention

The present invention relates to a dual-functional earphone; in particular, it relates to a dual-functional earphone providing handsfree and audio communications features.

2. Description of Related Art

With advancement in technologies, various new methods of communications have been developed, such that letters and telephones are no longer the only few options available for human communications. By using the earpiece and the microphone, through numerous wireless technologies and network connections, users are allowed to engage conversations with remote counterparts without any temporal or spatial restrictions, facilitating exchanges of ideas and feelings.

However, commercially-available earphones, no matter wired or wireless, adopt mostly the so-called general microphone; the reception function in such a general microphone whereas is difficult to control in that the general microphone receives not only the voice uttered by the user, but easily picks up various ambient background noises. If the user is located at a noisy and bustling location, the general microphone may receive many redundant but meaningless audio signals, which probably causes undesirable interferences to the remote counterpart in communications, or erroneously delivering the intended messages, leading to severe hindrance to effective communication for the user. Therefore, overcoming such interferences to message delivery becomes a key issue for maintenance of communication quality.

### SUMMARY OF THE INVENTION

The essential objective of the present invention is to provide a dual-functional earphone which integrates a general microphone and a vibration-based microphone, allowing users to effectively communicate with clarity in any environment.

To achieve the aforementioned objective, the present invention discloses a dual-functional earphone comprising a main casing; an earpiece disposed on a upper portion of the main casing; a microphone disposed on a lower portion of the main casing, in which the microphone is provided with a general microphone and a vibration-based microphone; a switch portion disposed on a surface of the main casing; and a circuit device, which is disposed inside the main casing and electrically connected to the earpiece, the microphone and the switch portion.

The vibration-based microphone is different from the general microphone in that, when the vibration-based microphone is placed near to the mouth or throat part of the user, it receives and amplifies only the vibrations from his/her vocal cord and suppresses other background hums, such that the counterpart at a remote place can distinctly hear the user's talk without being bothered by such additional but unnecessary messages.

The dual-functional earphone according to the present invention integrates the general microphone and the vibration-based microphone, thereby allowing the user to speak and hear expressly in different environments. In common and tranquil surroundings, the general microphone may be sufficiently operable; whereas, in a bustling environment, including situations such as car driving on a road, airports, various business and entertainment sites and the like, the vibration-based microphone can be switched ON for receiving only the user's voices to keep the conversation clear.

In order to further appreciate the characteristics and technical contents of the present invention, references are made to the following detailed descriptions and appended drawings which are provided simply for exemplary and illustrative purposes, rather than for applying any limitations to the scope of the present invention.

### BRIEF DESCRIPTION OF THE DRAWINGS

FIG. 1 is a perspective view of the switch portion, which is a type of electronic switch, in the dual-functional earphone according to the present invention;

FIG. 2 is a perspective view of the switch portion, which is a type of slide switch, in the dual-functional earphone according to the present invention;

FIG. 3 is a schematic block diagram of the switch portion, which is a type of electronic switch, in the dual-functional earphone according to the present invention; and

FIG. 4 is a schematic block diagram of the switch portion, which is a type of slide switch, in the dual-functional earphone according to the present invention.

### DETAILED DESCRIPTION OF THE PREFERRED EMBODIMENTS

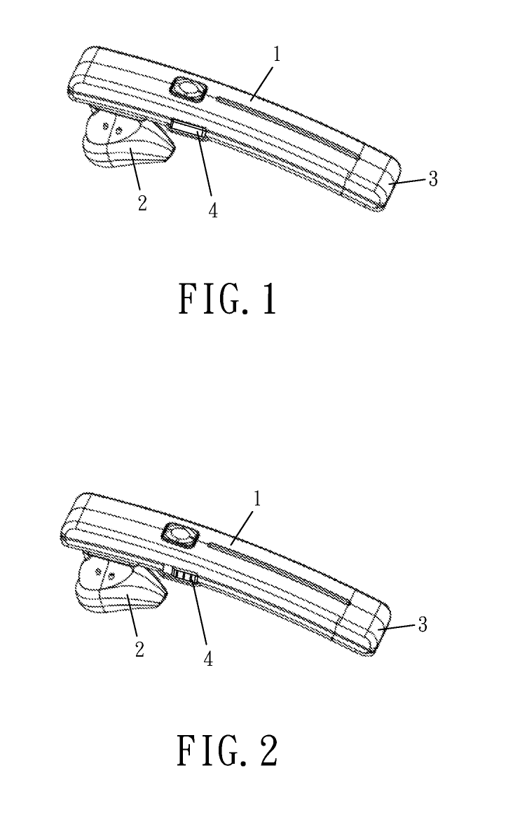

Refer now to FIGS. 1 to 4, wherein the present invention provides a dual-functional earphone which comprises a main casing 1, an earpiece 2, a microphone 3, a switch portion 4 and a circuit device 5.

The main casing 1 is approximately bar-shaped. The earpiece 2 is disposed on a upper portion of the main casing 1. The microphone 3 is disposed on a lower portion of the main casing 1, which includes a general microphone 31 and a vibration-based microphone 32. The switch portion 4 is disposed on a surface of the main casing 1. The circuit device 5 is disposed inside the main casing 1 and electrically connected to the earpiece 2, the microphone 3 and the switch portion 4.

In use, the earpiece 2 is secured to the ear of the user, the main casing 1 is attached to the cheek, and the microphone 3 is near to the mouth or throat part of the user.

The dual-functional earphone can be a Bluetooth wireless earphone or a wired earphone, and the switch portion 4 can be an electronic switch (as shown in FIG. 1) or a slide switch (as shown in FIG. 2) which allows to control the mode switching of the two types of microphone 3.

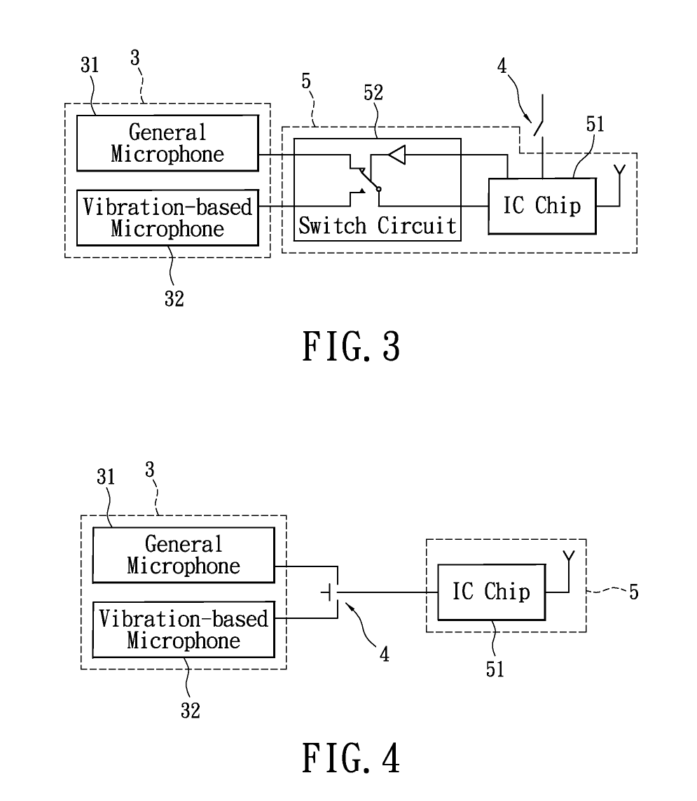

Refer to FIGS. 1 and 3, wherein the switch portion 4 is an electronic switch, e.g., a button. The circuit device 5 includes an Integrated Circuit (IC) chip 51 and a switch circuit 52, wherein one ends of the IC chip 51 and the switch circuit 52 are electrically connected with each other, while other end of the IC chip 51 is electrically connected to the switch portion 4 and the other end of the switch circuit 52 is electrically connected to the microphone 3. Through the electronic type switch portion 4, the IC chip 51 is driven to produce a signal to the switch circuit 52, such that the IC chip 51 is electrically connected to the general microphone 31 or the vibration-based microphone 32 for mode switching between the two types of microphone 3.

The user is allowed to select a suitable microphone 3 in accordance with environmental factors. When the dual-functional earphone is connected to a mobile phone for communications, the general microphone 31 can be used; in case the user is at a position surrounded by loud noises, the dual-functional earphone can be switched to the vibration-based microphone 32 by simply pressing down shortly the button on the switch portion 4, which microphone 32 being able to suppress ambient bustling sounds thereby allowing the counterpart to distinctly listen to the user's voice. When the user needs to switch back to the general microphone 31, it can be accomplished by simply pressing down shortly the button on the switch portion 4, thus switching the dual-functional earphone back to the general microphone 31.

Refer next to FIGS. 2 and 4, wherein the switch portion 4 is a slide switch. The circuit device 5 includes an IC chip 51 electrically connected to the switch portion 4. The switch portion 4 is electrically connected to the microphone 3, and through the slide type switch portion 4, the IC chip 51 is allowed to be electrically connected to the general microphone 31 or the vibration-based microphone 32 for mode switching between the two types of microphone 3.

The user is allowed to select a suitable microphone 3 in accordance with environmental factors. When the dual-functional earphone is connected to a mobile phone for communications, the general microphone 31 can be used; in case the user is at a position surrounded by loud noises, the dual-functional earphone can be switched to the vibration-based microphone 32 by simply selecting the slide switch in the switch portion 4 to the vibration-based microphone 32, so that the vibration-based microphone 32 is able to suppress ambient bustling sounds thereby allowing the counterpart to distinctly listen to the user's voice. When the user needs to return to the general microphone 31, it can be accomplished by simply selecting the slide switch in the switch portion 4 to the general microphone 31, thus switching the dual-functional earphone back to the general microphone 31.

The aforementioned descriptions illustrate merely the preferred embodiments of the present invention, rather than intending to limit the scope of the present invention thereto. All effectively equivalent modifications, changes or alternations made to the specification and appended drawings of the present invention are analogously deemed as being encompassed by the field of the present invention defined as the claims set forth hereunder.

What is claimed is:

1. A dual-functional earphone, comprising:
a main casing;
an earpiece disposed on a upper portion of the main casing;
a microphone disposed on a lower portion of the main casing, in which the microphone is provided with a general microphone and a vibration-based microphone;
a switch portion disposed on a surface of the main casing; and
a circuit device disposed inside the main casing and electrically connected to the earpiece, the microphone and the switch portion.

2. The dual-functional earphone according to claim 1, wherein the dual-functional earphone is a Bluetooth wireless earphone or a wired earphone.

3. The dual-functional earphone according to claim 1, wherein the switch portion is an electronic switch.

4. The dual-functional earphone according to claim 3, wherein the circuit device includes an Integrated Circuit (IC) chip and a switch circuit, one ends of said IC chip and said switch circuit being electrically connected with each other, the other end of the IC chip electrically being connected to the switch portion, and the other end of the switch circuit being electrically connected to the microphone.

5. The dual-functional earphone according to claim 1, wherein the switch portion is a slide switch.

6. The dual-functional earphone according to claim 5, wherein the circuit device includes an IC chip, said IC chip being electrically connected to the switch portion, and the switch portion being electrically connected to the microphone.
